(19) United States
(12) Patent Application Publication
(10) Pub. No.: US 2010/0144356 A1
(43) Pub. Date: Jun. 10, 2010

(54) Base station coordination through co-located relays

(76) Inventors: Qinghua Li, Sunnyvale, CA (US); Wendy C. Wong, San Jose, CA (US); Hujun Yin, San Jose, CA (US)

Correspondence Address: INTEL CORPORATION;c/o CPA Global, P.O. BOX 52050, MINNEAPOLIS, MN, 55402, US

(21) Appl. No.: 12/315,997

(22) Filed: Dec. 9, 2008

(51) Int. Cl. H04W 40/00; H04B 7/14; H04M 1/00

(52) U.S. Cl. 455/446; 455/7; 455/561

(57) ABSTRACT

A relay station, which is used to communicate between a base station and a subscriber station in a wireless communications network, may also be used to communicate between the base station and another base station in an adjacent network by having the relay station communicate a message to or from the other base station, either directly or through another relay station associated with the other base station. In some embodiments, relay stations in adjacent networks may be co-located, so that they can communicate with each other over a short high-speed link. In some embodiments this link may be suitable for direct digital communications rather than through modulated carrier signals.

### BACKGROUND

In wireless communications networks, deploying relay stations close to the cell edges can improve the network performance in terms of throughput and reliability, since the signal strength and/or signal quality may otherwise be marginal in those areas. However, the operator of the network has to pay for the real estate cost of each of the relay locations, and that cumulative cost can be considerable. Another issue in conventional wireless networks is that the base stations typically use a hard-wired ‘backbone’ network to communicate with each other. Although this backbone allows a base station to exchange information with base stations that are far away (e.g., in another state), using a network this large and complex frequently introduces a large amount of latency into such communications. This latency may introduce unacceptable delays into communications between base stations in adjacent cells that need to coordinate time-critical activities with each other.

### BRIEF DESCRIPTION OF THE DRAWINGS

Some embodiments of the invention may be understood by referring to the following description and accompanying drawings that are used to illustrate embodiments of the invention. In the drawings:

FIGS. 1A and 1B show a diagram of co-located relay stations in a physical arrangement of wireless network cells, according to an embodiment of the invention.

FIG. 2 shows a diagram of communications links between two base stations through their relay stations, according to an embodiment of the invention.

FIG. 3 shows a flow diagram of a method of communicating between base stations though their relay stations, according to an embodiment of the invention.

FIG. 4 shows a diagram of a wireless communications device, according to an embodiment of the invention.

FIG. 5 shows a diagram of communications links between two base stations through a single relay station, according to an embodiment of the invention.

FIG. 6 shows a flow diagram of a method of communicating between base stations though a single relay station, according to an embodiment of the invention.

FIG. 7 shows a flow diagram of a method of communicating between base stations though a relay station, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a computer-readable medium, which may be read and executed by one or more processors to enable performance of the operations described herein. A computer-readable medium may include any mechanism for storing, transmitting, and/or receiving information in a form readable by one or more computers. For example, a computer-readable medium may include a tangible storage medium, such as but not limited to read only memory (ROM); random access memory (RAM); magnetic disk storage media; optical storage media; a flash memory device, etc. A computer-readable medium may also include a propagated signal which has been modulated to encode the instructions, such as but not limited to electromagnetic, optical, or acoustical carrier wave signals.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not. The term “mobile” wireless device is used to describe a wireless device that may be in motion while it is communicating.

In various embodiments of the invention in which relay stations are used with base stations in a collection of wireless network cells, some of the relays from different cells may be co-located and communicate directly with each other to pass information from one base station to another without having to depend on the conventional backbone network for such inter-base station communication and co-ordination. In some embodiments, the co-located relays may exchange information in the digital domain through a wired connection. In other embodiments, the co-located relays may exchange information through a fast wireless link (such as but not limited to a wireless local area network). In still other embodiments, a single relay station may wirelessly communicate directly with two or more base stations to transmit information between those base stations. Not only will this approach save real estate costs by reducing the number of locations needed for the relay stations, but it may be potentially faster than a wired backbone because the relays do not have to share a wired network with many other stations for this communication.

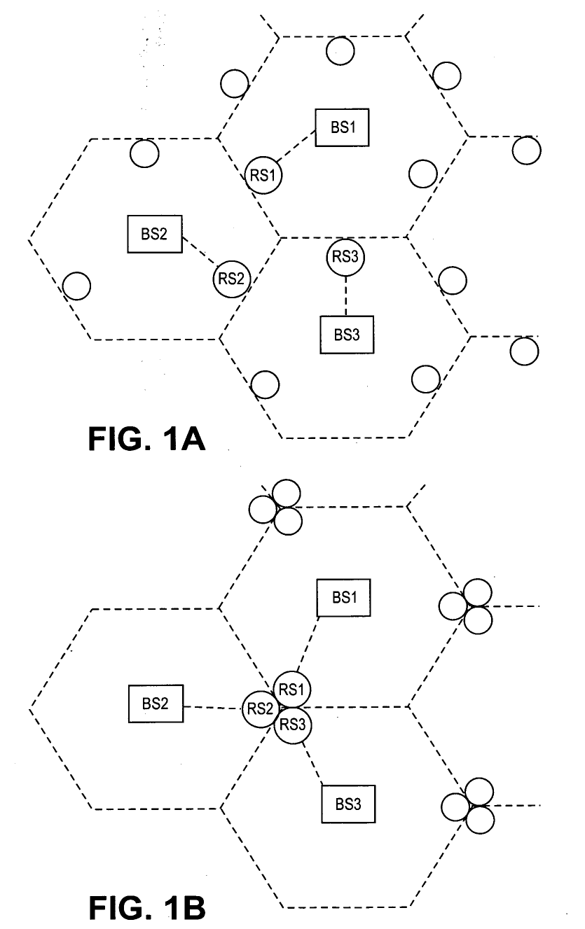

FIGS. 1A and 1B show a diagram of co-located relay stations in a physical arrangement of wireless network cells, according to an embodiment of the invention. FIG. 1A shows a collection of adjacent wireless network cells, with individually-located relays scattered about in various places. For simplicity, only three full cells are shown, but the general pattern of cells may be assumed to extend beyond these three. Each base station (BS, shown as a square) provides overall scheduling and control of wireless communications within its own cell, with its cell being generally indicated by the dashed lines forming a hexagon around it. Each relay station (RS, shown as a circle) exchanges information between the BS and various subscriber stations (SS, not shown) in the cell that are associated with that base station.

Within the context of this document, a “base station” is a wireless communications device that provides overall centralized scheduling for communications by other wireless devices that are associated with that base station. Base stations may also be labeled with other terms, such as network controller, access point, etc., and the term “base station” in this document is meant to encompass such devices that are labeled with other terms, unless the accompanying description explicitly excludes them. Within the context of this document, the term “associated” refers to a base station and another wireless communications device establishing an agreed-upon communications relationship with each other, such that they may communicate with each other following specific rules of format, protocol, timing, and frequency(s). In this document, the term “associated” is used to refer to a subscriber station that communicates directly with the base station, or indirectly with the base station through a relay station, and may also be used to refer to the relay station that communicates directly with the base station. In most such associations, the base station generally controls when the other devices may communicate with it (and communicate with each other, when applicable), but there may also be instances in which the other device is able to communicate without such direct control by the base station.

In this example relay station RS1 communicates with base station BS1 to relay communications between BS1 and the SS's that are associated with BS1. Similarly, RS2 communicates with BS2, and RS3 communicates with BS3, to relay information to their respective SS's. Only relay stations RS1, RS2, and RS3 are labeled, but the principles described here may be applied to some or all of the other relay stations indicated as circles in the drawing in other cells. In actual operation, the physical placement of the RS's and the shape of the cells will usually not be as orderly as shown in the drawings (e.g., the drawing shows symmetrically-formed hexagonal cells, relay stations at regular points in each cell, etc.), but the general principles described here may be applied in full or in part to many actual physical layouts.

Sometimes, two nearby BS's may need to exchange time-critical information with each other. Such information may include things such as, but not limited to: 1) the imminent handover of an SS from one BS to another, 2) allocation of non-interfering frequencies along the shared cell edge of adjacent cells (fractional frequency reuse), 3) directional interference nulling in the region of the shared cell edge of adjacent cells, 4) allocation of non-interfering time slots in the region of the shared cell edge of adjacent cells, 5) uplink sounding, 6) etc. Exchanging this information through the conventional wired backbone that connects many base stations to each other may introduce communication latencies that are too large to reliably handle this time-critical information.

FIG. 1B shows a similar network, but with some of the relay stations from adjacent cells co-located. In the illustrated example, relay stations RS1, RS2, and RS3 have been co-located in a small area in which each RS is still accessible to its respective BS. Other, non-labeled, RS's have also be shown as grouped together, but only RS1, RS2, and RS3 are described here in detail. In actual practice, a mixture of co-located relay stations and individually located relay stations may be placed in a given geographical area.

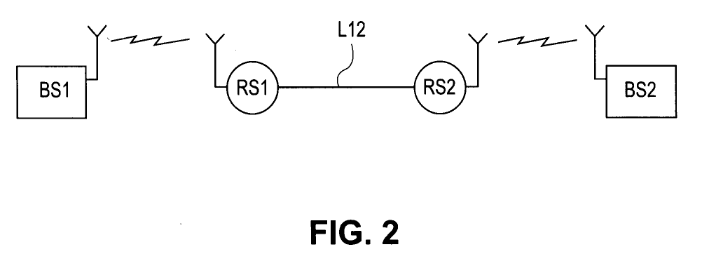

FIG. 2 shows a diagram of communications links between two base stations through their relay stations, according to an embodiment of the invention. In the illustrated networks, a base station BS1 may communicate wirelessly with its associated relay station RS1, while a base station BS2 may communicate wirelessly with its associated relay station RS2. BS1 and BS2 may be the network controllers for two adjacent network cells. RS1 and RS2 communicate with each other through a communications link L12.

Communications link L12 may take any of various forms, such as but not limited to: 1) a hardwired communication link such as a data cable, 2) a short range high-speed wireless link (e.g., Bluetooth, piconet, etc.), 3) a storage unit, such as shared RAM memory, that is accessible by both RS1 and RS2, 4) etc. RS1 and RS2 may also be co-located. This co-location may be implemented in various ways, such as but not limited to: 1) processing units for the relay stations may be located in the same structure (e.g., building, cabinet, etc.), 2) antennas for the relay stations may be mounted on the same tower, 3) the relay stations may be located close together without any common physical structure, 4) etc. Although only two relay stations are shown in FIG. 2, other embodiments may include three or more relay stations co-located and communicating with each other.

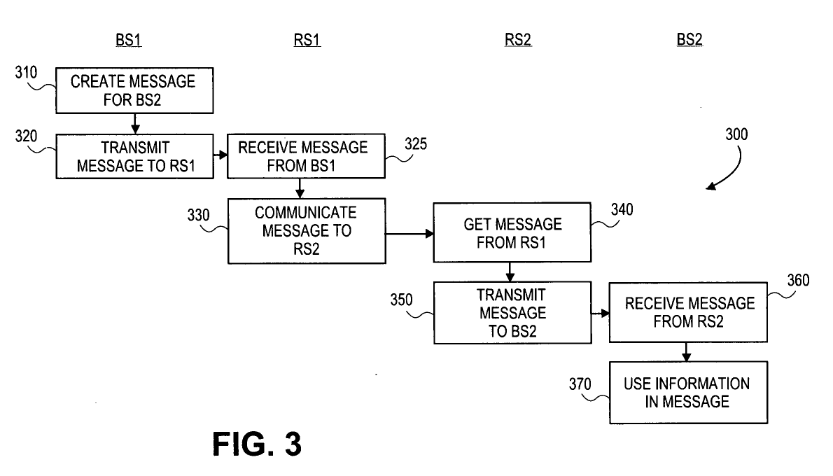

FIG. 3 shows a flow diagram of a method of communicating between base stations though relay stations, according to an embodiment of the invention. In the illustrated flow diagram 300, at 310 a base station BS1 may originate a message that is destined for another base station BS2. The term “originate”, as used herein, indicates creating a message, rather than just forwarding a message that was created in another station. The term “destined”, as used herein, indicates that the message is to be ultimately delivered to that station, though it may or may not be routed through one or more other stations before arriving there. In some operations the original message may contain the destination station's address, but in other operations the content of the original message may be interpreted by a relay station to determine that the message should be delivered to the destination station, even though the destination station's address was not in the original message. A “message”, as that term is used here, contains information to be delivered from an originating base station to a destination base station, although the message may pass through relay stations between the originating base station and the destination base station. The message may be contained in one or more separate transmissions. The message may also be combined with, or separated from, other information at various points in its journey from BS1 to BS2. The protocols used to communicate the message may change at various points between BS1 and BS2. In some embodiments, BS1 operates as a network controller for a first network cell, while BS2 operates as a network controller for a second network cell adjacent to the first network cell, but in other embodiments the network cells may not be adjacent.

At 320, BS1 may transmit the message to RS1, with sufficient information that RS1 is aware that this message is to be communicated to RS2 rather than to one of the subscriber stations associated with BS1. At 325 RS1 may receive the message from BS1, and at 330 RS1 may then communicate the message to RS2 for eventual delivery to BS2. As previously described, the communication between RS1 and RS2 may take any of various forms. In some embodiments, the communication between RS1 and RS2 may be at the digital level, for example through a direct-link cable, a shared storage unit, etc. In other embodiments, the communication between RS1 and RS2 may be via a modulated signal, with the relevant modulation techniques, channel access protocols, addressing, etc. In some embodiments, the communication between RS1 and RS2 may be wireless, while in other embodiments it may be through a wired connection. When RS2 obtains the message at 340, it may then transmit the message wirelessly to BS2 at 350. When BS2 receives the message from RS2 at 360, it may use the information in the message appropriately at 370.

The information in the message may be used for any feasible purpose, but one of the more common purposes may be to coordinate various communication activities by BS1 and BS2, coordination that is sufficiently time-critical that communicating the information through the normal backbone network could introduce unacceptable delays. Such activities may include things such as, but not limited to: 1) a possible or definite handoff of a subscriber station between BS1 and BS2, 2) beamforming activities by various devices in the two networks so that a device in one network is unlikely to interfere with a device in the other network, 3) frequency assignments among devices in the two networks near the shared cell edge boundaries so that a device in one network is unlikely to interfere with a device in the other network, 4) etc.

Although the foregoing descriptions only describe two co-located relay stations, to exchange information between two base stations, the principles described may easily be extended to cover three or more co-located relay stations to forward information between three or more base stations. In some embodiments, the relay stations may be fixed in place (e.g., located in a building, fixed to a structure, etc.), while in other embodiments the relay stations may be mobile (e.g., in/on a vehicle, hand-carried, etc.).

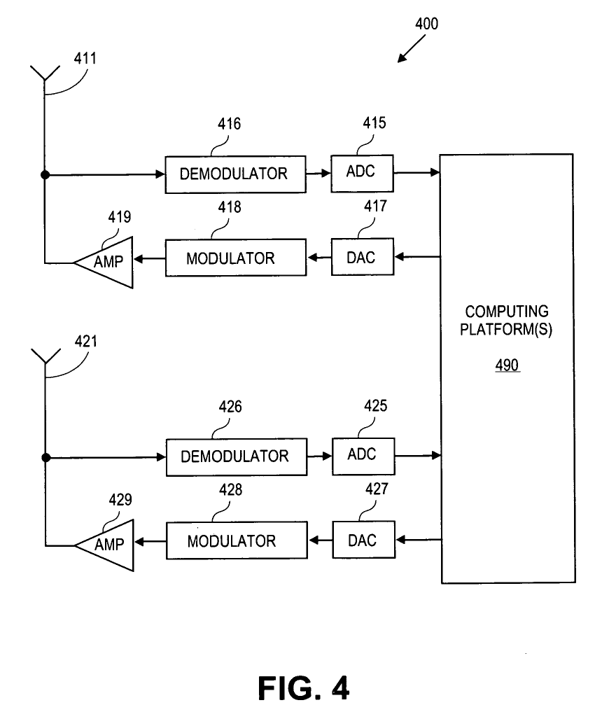

FIG. 4 shows a diagram of a wireless communications device, according to an embodiment of the invention. Any of the aforementioned devices BS1, BS2, RS1, or RS2 may contain some or all of the components shown in illustrated device 400. For example, one or more computing platforms 490 may be used to control overall operations of the device 400. A computing platform may contain one or more processors, including an applications processor and/or a digital signal processor. This particular embodiment shows two antennas 411 and 421, but other embodiments may contain one, three, or more antennas, each with necessary supporting components. In this example, antenna 411 is coupled to a demodulator 416 to demodulate the received signal and convert it to a baseband signal. The baseband signal may then be converted to digital format with analog-to-digital converter (ADC) 415. For transmissions, digital signals may be converted to analog with digital-to-analog converter (DAC) 417. The analog signals may then be modulated onto a radio frequency (FR) carrier wave through modulator 418, and then amplified in power amp 419 for transmission through antenna 411.

Similar functionality may be provided for antenna 421 by demodulator 426, ADC 425, DAC 427, modulator 428, and amplifier 429. FIG. 4 shows one embodiment of a configuration of a wireless communications device, but other embodiments may use different components, and/or may arrange components in a different manner than shown.

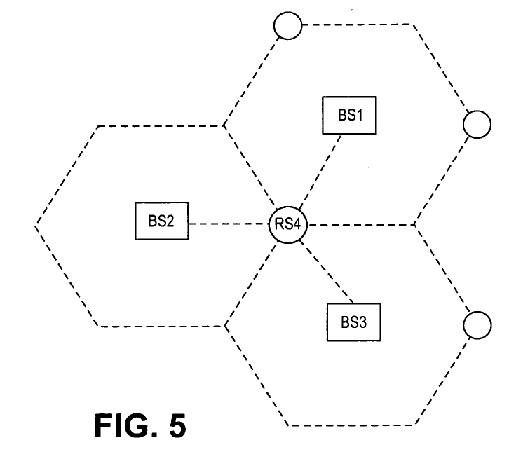

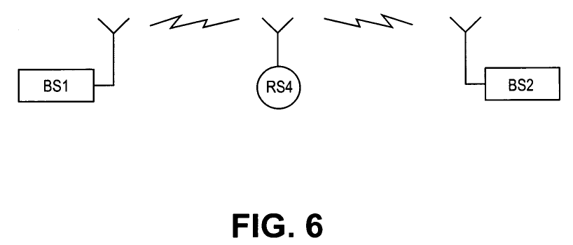

FIGS. 5 and 6 show diagrams of a relay station shared by multiple base stations, according to an embodiment of the invention. As compared with FIGS. 1B and 2, in which each relay station is associated with only one base station, in FIGS. 5 and 6 a single relay station may be associated with multiple base stations and communicate directly with any of them. The illustrated example shows a relay station associated with three base stations, but in other embodiments a relay station may be associated with only two, or with more than three, base stations. When a message from one base station is destined for another base station in an adjacent cell (e.g., from BS1 to BS2), the message may be transmitted from the originating base station BS1 to a relay station (e.g., RS4) that is associated with both base stations, and the relay station RS4 may transmit that message to base station BS2. This permits the BS-to-BS communication to take place through only one relay station instead of two as was described in FIG. 1B. In some embodiments, this relay station may also be used to relay communications between one of the base stations and the subscriber stations associated with that base station. In other embodiments, this relay station may be used to relay communications between each of multiple base stations and the subscriber stations associated with each of those base stations.

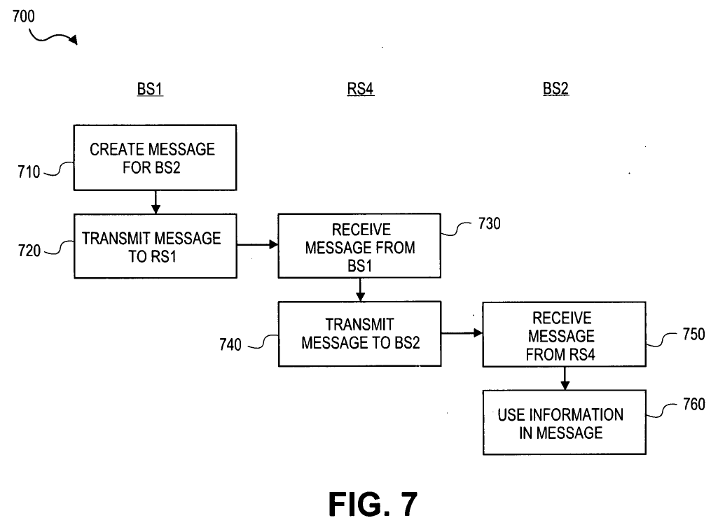

FIG. 7 shows a flow diagram of a method of communicating between base stations though a relay station, according to an embodiment of the invention. At 710, base station BS1 may create a message destined for base station BS2, and transmit that message to relay station RS4 at 720. RS4 may receive that message at 730, determine that the message is destined for BS2, and transmit the message to BS2 at 740. The message may be received from RS4 by BS2 at 750, and BS2 may then use the information appropriately at 760.

The previous descriptions have focused on communications from a first base station, communications that are intended by that first base station to be routed through the relay station to a second base station (e.g., by having the second base station's address listed as the ultimate destination). But in other embodiments, the relay station itself may decide to route a communication to the second base station, even though the second base station was not listed as the ultimate destination by the first base station. For example, when BS1 schedules communications in its network by distributing a downlink MAP to the devices in BS1's network (including a relay station RS), the RS may determine that the MAP would be beneficial to BS2 in an adjacent network. By having this MAP, BS2 can schedule communications in its own network in a way that will not interfere with communications in BS1's network. In this instance, RS may forward the MAP to BS2, either directly (if RS is associated with both base stations as in FIG. 5) or indirectly (if RS1 delivers the MAP to RS2 which delivers the MAP to BS2 as in FIG. 1B). In addition to MAPs, there are many other forms of data that the RS might decide to forward to BS2, without being prompted to do so by the originating BS.

The foregoing description is intended to be illustrative and not limiting. Variations will occur to those of skill in the art. Those variations are intended to be included in the various embodiments of the invention, which are limited only by the scope of the following claims.

What is claimed is:

1. An apparatus, comprising
a first relay station to communicate wirelessly in a wireless communications network, the first relay station having a computing platform, a modulator, and a demodulator, wherein the first relay station is to:
communicate a first message originated by a first base station and destined for a second base station; and
communicate a second message between one of the first and second base stations and a first subscriber station associated with said one of the first and second base stations.

2. The apparatus of claim 1, wherein:
the first relay station is to wirelessly receive the first message from the first base station and communicate the first message to a second relay station associated with the second base station.

3. The apparatus of claim 2, wherein the first relay station is to communicate the first message to the second relay station by using a technique selected from a list consisting of:
a) transmitting the first message to the second relay station through a cable;
b) transmitting the first message to the second relay station wirelessly; and
c) placing the first message in a storage unit accessible by both the first and second relay stations.

4. The apparatus of claim 1, wherein the first relay station is to obtain the first message from a second relay station associated with the first base station and wirelessly transmit the first message to the second base station; the first relay station being associated with the second base station.

5. The apparatus of claim 4, wherein the first relay station is to obtain the first message from the second relay station by using a technique selected from a list consisting of:
a) receiving the first message from the second relay station through a cable;
b) receiving the first message from the second relay station wirelessly; and
c) reading the first message from a storage unit accessible by both the first and second relay stations.

6. The apparatus of claim 1, wherein:
the first relay station is to wirelessly receive the first message from the first base station and wirelessly transmit the first message to the second base station; and
the first relay station is to be associated with the first base station and associated with the second base station.

7. The apparatus of claim 6, wherein the first relay station is to communicate a third message between another of the first and second base stations and a second subscriber station associated with said another of the first and second subscriber stations.

8. The apparatus of claim 1, wherein the first relay station is associated with the first base station and is co-located with a second relay station associated with the second base station, the manner of co-location selected from a list consisting of:
a) located within a same structure;
b) sharing a tower for mounting a first antenna coupled to the first relay station to communicate between the first relay station and the first base station and for mounting a second antenna coupled to the second relay station to communicate between the second relay station and the second base station; and
c) located close enough to communicate with each other using short range wireless communications.

9. The apparatus of claim 1, wherein the first message is to contain an address of the second base station before the first message is received by the first relay station.

10. The apparatus of claim 1, wherein:
the first message is not to contain an address of the second base station before the first message is received by the first relay station; and
the first relay station is to determine, based on content of the first message, that the first message is to be delivered to the second base station.

11. A method, comprising:
communicating, by a first relay station, a first message that was originated by a first base station and is destined for a second base station;
communicating, by the first relay station, a second message between one of the first and second base stations,and a first subscriber station associated with said one of the first and second base stations.

12. The method of claim 11, wherein said communicating the first message comprises wirelessly receiving the first message from the first base station and communicating the first message to a second relay station associated with the second base station.

13. The method of claim 12, wherein said communicating the first message to the second relay station comprises using a technique selected from a list consisting of:
a) transmitting the first message to the second relay station through a cable;
b) transmitting the first message to the second relay station wirelessly; and
c) placing the first message in a storage unit accessible by both the first and second relay stations.

14. The method of claim 11, wherein said communicating the first message comprises obtaining the first message from a second relay station associated with the first base station and wirelessly transmitting the first message to the second base station; the first relay station being associated with the second base station.

15. The method of claim 14, wherein said obtaining first message from the second relay station comprises using a technique selected from a list consisting of:
a) receiving the first message from the second relay station through a cable;
b) receiving the first message from the second relay station wirelessly; and
c) reading the first message from a storage unit accessible by both the first and second relay stations.

16. The method of claim 11, wherein said communicating the first message comprises:
wirelessly receiving the first message from the first base station and wirelessly transmitting the first message to the second base station, wherein the first relay station is associated with the first base station and is associated with the second base station.

17. The method of claim 16, further comprising communicating, by the first relay station, a third message between another of the first and second base stations and a second subscriber station associated with said another of the first and second base stations.

18. The method of claim 11, wherein the first message contains an address of the second base station before the first message is received by the first relay station.

19. The method of claim 11, wherein:
the first message does not contain an address of the second base station before the first message is received by the first relay station; and
the first relay station determines, based on content of the first message, that the first message is to be delivered to the second base station.

20. An article comprising
a tangible computer-readable medium that contains instructions, which when executed by one or more processors in a first relay station, result in performing operations comprising:
communicating a first message that was originated by a first base station and is destined for a second base station;
communicating a second message between one of the first and second base stations and a first subscriber station associated with said one of the first and second base stations.

21. The article of claim 20, wherein the operation of communicating the first message comprises wirelessly receiving the first message from the first base station and communicating the first message to a second relay station associated with the second base station.

22. The article of claim 21, wherein the operation of communicating the first message to the second relay station comprises using a technique selected from a list consisting of:
a) transmitting the first message to the second relay station through a cable;
b) transmitting the first message to the second relay station wirelessly; and
c) placing the first message in a storage unit accessible by both the first and second relay stations.

23. The article of claim 20, wherein the operation of communicating the first message comprises obtaining the first message from a second relay station associated with the first base station and wirelessly transmitting the first message to the second base station; the first relay station being associated with the second base station.

24. The article of claim 23, wherein the operation of obtaining first message from the second relay station comprises using a technique selected from a list consisting of:
a) receiving the first message from the second relay station through a cable;
b) receiving the first message from the second relay station wirelessly; and
c) reading the first message from a storage unit accessible by both the first and second relay stations.

25. The article of claim 20, wherein the operation of communicating the first message comprises:
wirelessly receiving the first message from the first base station and wirelessly transmitting the first message to the second base station, wherein the first relay station is associated with the first base station and is associated with the second base station.

26. The article of claim 25, wherein the operations further comprise communicating, by the first relay station, a third message between another of the first and second base stations and a second subscriber station associated with said another of the first and second base stations.

27. The article claim 20, wherein the first message contains an address of the second base station before the first message is received by the first relay station.

28. The article of claim 20, wherein:
the first message does not contain an address of the second base station before the first message is received by the first relay station; and
the first relay station determines, based on content of the first message, that the first message is to be delivered to the second base station.

29. An apparatus, comprising:
a first base station having a processor and at least one antenna to communicate wirelessly with a subscriber station associated with the first base station through a relay station, the first base station to also communicate information with a second base station through the first relay station;
wherein the first base station, the relay station, and the subscriber station are each part of a same wireless communications network.

30. The apparatus of claim 29, wherein the information is to be transmitted by the first base station to the relay station and destined for the second base station.

31. The apparatus of claim 29, wherein the information is to be received by the first base station from the relay station and originated in the second base station.

32. The apparatus of claim 29, wherein the information is to be related to coordinating operations between the first and second base stations.

33. The apparatus of claim 32, wherein the information is selected from a list consisting of:
a) scheduling information about communications in the wireless communications network;
b) information about transmit beamforming in the wireless communications network;
c) information about fractional frequency reuse in the wireless communications network;
d) information about uplink sounding in the wireless communications network; and
e) information about handover of the subscriber station from the first base station to the second base station.

34. An article comprising
a tangible computer-readable medium that contains instructions, which when executed by one or more processors result in performing operations comprising:
wirelessly transmitting information from a first base station to a relay station associated with the first base station in a wireless network, the information destined for a second base station not in the first network.

35. The article of claim 34, wherein the information is related to coordinating operations between the first and second base stations.

36. The article of claim 35, wherein the information is selected from a list consisting of:
a) scheduling information about communications in the wireless network;
b) information about transmit beamforming in the wireless network;
c) information about fractional frequency reuse in the wireless network;
d) information about uplink sounding in the wireless network; and
e) information about handover of the subscriber station from the first base station to the second base station.
